(19) United States
(12) Patent Application Publication
(10) Pub. No.: US 2014/0227508 A1
(43) Pub. Date: Aug. 14, 2014

(54) FOAM COMPOSITION FOR BUILDING PURPOSES

(71) Applicant: Tremco illbruck Productie B.V., Arkel (NL)

(72) Inventors: Siebe SCHOOTSTRA, Gorinchem (NL); Goslin van HERPEN, Hardinxveld-Giessendam (NL)

(21) Appl. No.: 14/082,326

(22) Filed: Nov. 18, 2013

(30) Foreign Application Priority Data
Nov. 20, 2012 (DE) 20 2012 104 490.0

(51) Int. Cl. C09J 109/08; B32B 7/12

(52) U.S. Cl. CPC C09J 109/08; B32B 7/12
USPC 428/317.5; 521/71; 156/71; 156/79

(57) ABSTRACT

A foam composition for building purposes, particularly for filling joints or connecting construction parts, contains a foamable aqueous phase and a propellant which foam when sprayed together through a nozzle. The foamable aqueous phase contains at least one organic polymer and inorganic components, which include a silicate chemically dissolved in the aqueous phase, the solution of which is film-forming. The organic polymer is present in the form of a dispersion or aqueous solution and produces a silicate-polymer-foam when foamed together with the silicate solution. The organic polymer is contained at ≧3% by weight, the water-soluble silicate is contained at ≧3% by weight, and the organic polymer and the water-soluble silicate are contained at a weight ratio of 20:1 to 1:20, based in each case on their dry substance in the aqueous phase.

### BACKGROUND OF THE INVENTION

This invention relates to a foam composition for building purposes, particularly for filling joints or for connecting construction parts, the foam composition comprising a foamable aqueous phase and a propellant, wherein the foamable aqueous phase at least comprises one organic film-forming polymer and inorganic components.

Such foams for building purposes which are produced by foaming the foam composition, must altogether meet a complex profile of requirements. For example, they must have a foam stability which is sufficient for filling joints. Further, in the freshly foamed condition, such foams must have a consistency which is sufficiently viscous so that prior to curing the foams do not collapse in the joint or sag in a vertical joint or in a ceiling joint and, in the case of adhesive foams, form a continuous adhesive bead. For filling the respective joint in a manner which is reliable from the aspect of structural engineering, the foam is additionally required to exhibit a shrinkage behavior with only little shrinkage, if at all, during curing. Further, such foams must provide particularly good adhesion to the respective substrate, which mostly is a mineral building material such as lime sand brick or concrete or also a plastic material or the like, so as to obtain a durable connection to the respective material of the construction upon filling a joint or gluing construction parts. Further, the setting time of such foams must be short enough so that the same still sufficiently fill the respective joint if the foam tends to collapse, and/or the processing time is sufficiently short. On the other hand, the foam should not be setting excessively fast because this might involve a risk of cracks being formed in the cured foam and/or humidity being discharged too slowly from the foam to the outside during the curing process of the foam, which again would be a disadvantage. Further, the foam should still exhibit certain flexibility, especially when it is used as joint foam filler, so that it does not crack when the construction parts forming the joint move to each other. Finally, the foam should meet environmental requirements, the foam composition (even before foaming) containing for instance a percentage of noxious or polluting components such as isocyanates which is as low as possible so that remaining quantities of the foam can be easily disposed, for instance without special refuse treatment.

Further, the foam composition shall be suitable for application as canned foam, hence for application on site using a can filled with propellant gas, with no special equipment required.

Further, if possible, the foam composition, which together with the propellant gas is filled into a container or can, should have high storage stability, particularly also as a one-component foam.

Previously known foams for building purposes mostly meet this complex profile of requirements only partly and insufficiently.

European patent application publication EP 2 064 298 A1, for example, discloses an adhesive foam which is designed as a collapsing foam. This canned PU foam contains, however, free isocyanates which might pose health risks, especially in contact with human skin.

On various occasions, alkali silicate solutions are used as a foam component, because these are environmentally friendly. From European patent application publication EP 0 922 834 A2 a sealing foam is known, for example, which can be used for sealing belowground areas. In addition to an alkaline metal silicate solution, this foam contains low percentages of cross-linked polyacrylate polymers as a gellant for adjusting the viscosity of the composition.

Further, from U.S. patent application publication U.S. 2009/0239429 foams are known which contain silicates and organic polymers for the factory-production of structural panels in which vinyl acetate is used as a polymer. In this case, however, semi-rigid or rigid foams are used for producing structural panels with a high degree of sound insulation. But foams which are employed in such industrial production processes are required to exhibit property profiles different from those of construction foams used for filling joints, connecting construction parts or similar purposes, especially concerning their curing time in combination with the given foam stability, adhesion to the respective structural component and the like.

From International patent application publication WO 2001/70647 A1 it is known to use foams for the production of molded bodies in hollow molds, wherein the foamable aqueous phase comprises a hydraulically setting inorganic component, such as Portland cement, as well as organic particulate fillers. The cement material is present in a powdery form finely dispersed in the foam composition. Alkaline metal silicate solutions can be used as a gellant for adjusting the viscosity. However, as the hydraulically setting inorganic material is relatively rapidly curing, it merely allows the production of foams whose rigidity or elasticity vary only within comparatively small ranges, and in which the processing of the uncured foamed material, e.g. for leveling a joint filling or for producing an even surface of the foam, is only conditionally accomplishable. Although these foams can be cut through after curing using a tool, such as a knife for example, so as to obtain an even surface and for removing excessive foam, this destroys or adversely affects the surface of the foamed material. These foam compositions are adapted for industrial production processes and do not qualify for canned foams.

### BRIEF SUMMARY OF THE INVENTION

The invention is based on the object of providing a foam or foam composition that can be used particularly as construction foam for filling joints and/or for gluing construction parts on site, wherein the foam or foam composition provides good adhesion to the respective substrate and can be processed, e.g. by smoothing the joint filling foam inserted into the joint, before the foam is cured, and can be applied as a canned foam, preferably as a one-component canned foam.

This object is achieved by a foam composition for building purposes, particularly for filing joints or for connecting construction parts, the composition containing a foamable aqueous phase and a propellant which foam when sprayed together through a nozzle, wherein the foamable aqueous phase comprises at least one organic polymer and inorganic components, characterized in that the inorganic components comprise a silicate chemically dissolved in the aqueous phase, the solution of which is film-forming,

that the organic polymer is present in the form of a dispersion or an aqueous solution and produces a silicate-polymer-foam when foamed together with the silicate solution,

that the organic polymer is contained at a percentage of ≧3% by weight, based on its dry substance in the aqueous phase,

that the water-soluble silicate is contained at a percentage of ≧3% by weight, based on its dry substance in the aqueous phase, and

that the organic polymer and the water-soluble silicate are contained at a weight ratio of 20:1 to 1:20, based in each case on their dry substance in the aqueous phase.

In a preferred embodiment, the invention is achieved by a foam in which the inorganic components comprise silicate chemically dissolved in an aqueous phase (such as water glass for example), the organic polymer is present in a manner dispersed in the aqueous phase in the form of a latex dispersion or a chemical solution for producing a silicate-polymer-foam during the foaming of the composition with the water-soluble silicate, wherein the organic polymer is contained in the aqueous phase (without propellant) at a percentage of ≧3% by weight, based on its dry substance, wherein the water-soluble silicate is contained in the aqueous phase at a percentage of ≧3% by weight, based on its dry substance, and wherein the organic film-forming polymer and the water-soluble silicate are contained in the aqueous solution at a weight ratio of 20:1 to 1:20, preferably at a weight ratio of 12:1 to 1:12, based on their respective dry substance.

Accordingly, in the foam of the invention, the organic polymer and the water-soluble silicate (or the aqueous silicate solution, e.g. as water glass) constitute the essential or the only components which construct the cell walls of the foam structure in a film-forming manner and thus are decisive for the firmness and/or elasticity of the foam both in the non-cured condition (immediately after the foaming process) and/or after its curing, preferably its complete curing. Both the silicate which is present in the dissolved form and preferably also the organic polymer are film-forming components independently and especially in combination with each other. After spreading and drying the polymer dispersion or polymer solution on a substrate surface, a coherent polymer film is produced. Since the organic polymer is present in the aqueous phase in a dispersed or dissolved form, it is also present in the dispersed or dissolved form in the aqueous silicate solution (under the selected conditions). Here the organic polymer (dry substance) is contained in the aqueous phase of the foam (without propellant) at a percentage of ≧3% by weight or preferably ≧5-8% by weight or ≧10-12% by weight.

The indication “≧x-y” (where x and y are two different figures), for example in relation to the values % by weight or % by volume, without being restricted thereto, in general do cover the indications “≧x” and “≧y”, independently from one another.

The indication “≦x-y” (where x and y are two different figures), for example in relation to the values % by weight or % by volume, without being restricted thereto, in general do cover the indications “≦x” and “≦y”, independently from one another.

The composition according to the invention especially is adapted to cure at room temperature (23° C.) and normal pressure (1013 hPa) and normal humidity, e.g. 50% relative humidity. Curing takes place by or under, respectively water loss of the composition. To achieve curing, no further impacts, like curing agents, radiation (e.g. UV or IR radiation) or the like, are necessary. If applicable, curing can be achieved by drying and water loss at room temperature and normal pressure, also at other humidity values, e.g. in the region of 0-80% or up to 90% or up to 95% of relative humidity, or even at higher values. Especially, curing also can be applied at 10-35° C., without being restricted thereto.

The properties of the foam in the just foamed condition (fresh foam) and also in the cured condition can be varied within vast ranges by a variation of the weight ratio of the organic polymer to the water-soluble silicate (dry substance content), so that flexible soft foams on one hand and rigid foams or semi-rigid foams on the other hand can be produced by that composition.

Here, the silicate dissolved in the aqueous solution is a component having film-forming properties, differently from water-insoluble silicates for example, which merely constitute filling substances for instance in the form of dispersed solids. At the same time also, the consistency of the fresh foam or the consistency of the liquid phase constructing the cell walls is adjusted by the water-soluble silicate.

The foam composition of the invention is particularly characterized by good homogenizability by shaking the foam can, and by good foam stability. In particular, the organic polymer can be present as a dispersion, which can generally apply within the scope of the invention.

### DETAILED DESCRIPTION OF THE INVENTION

Particularly preferably, the polymer, especially in its quality as a film-forming polymer, comprises an elastomer or predominantly or completely consists of elastomers, or at least one or more polymer precursors are present in the aqueous phase, which form an elastomer after the formation of the foam, particularly during its curing and/or drying. Such precursors can for instance be oligomers comprising suitable functional groups for chain extension so as to form an elastomeric polymer by chain extension. Such functional groups can for example react with each other in condensation or addition reactions while producing ester, amide, or ether groups for example. Such precursors are generally known. Because the organic polymer or at least one of the organic polymers is formed as an elastomer (or an elastomer is formed from precursors after foaming), the cured foam can exhibit particularly high elasticity or expansibility, with percentages of the polymer components or their precursors which may already be comparatively low. The dried polymer film thus preferably constitutes an elastomer film or a film including elastomeric regions that may continuously extend over the extent of the film. In combination with the water-soluble silicate, particular properties of the foam can be achieved or adjusted thereby, and in particular this foam is environmentally beneficial due to its content of water-soluble silicate on one side and on the other side the foam exhibits good adhesion to mineral construction parts such as concrete, lime sand brick or the like, and also a certain rigidity and resistance to compression (residual volume at a defined compressive force) due to the hardening silicate components. Here it is important that water-soluble silicates are used as inorganic components, which are thus film-forming components of the cell structure of the foam. As a result of the hardened film-forming silicate regions of the cell structure of the foam, the latter is compressible upon application of a force by a smaller amount than pure polymer foam or a polymer foam having distributed therein (water-insoluble) inorganic solids, which accordingly do not influence the wall structure of the cell walls that are constructed from a film-forming material. On the other hand, with a small percentage of water-insoluble solids, the foam of the invention may exhibit comparatively high rigidity at low or medium forces at which the cell walls are not yet destroyed by the exertion of pressure, but at the same time can have yet certain elasticity or expansibility with elastic restoring properties due to the elastomeric polymer components.

Particularly preferably, at least one organic polymer of the aqueous phase is type R rubber material and/or type M rubber material, or the organic polymer is composed thereof. Here type R rubber material is a rubber material with a continuous C—C basic structure (backbone) of the polymer and unsaturated C—C double bonds in the basic structure. Type M rubber material is one having a continuous C—C basic structure (continuous polymethylene chains) of the polymer and without unsaturated C—C double bonds in the basic structure. Preferably, within the scope of the invention, the type R rubber material and/or type M rubber material is a film-forming polymer, respectively.

Particularly preferably, the polymer material predominantly (for ≧30-45% by weight or ≧50-65% by weight or particularly preferably ≧75-85% by weight or ≧90-95% by weight) or completely consists of type R rubber material, based on the total weight of the polymer. Such components turned out to be particularly preferable as they produce comparatively high elasticity of the cured foam already at comparatively low percentages. Further, due to the elastomeric components of the polymer, particularly due to type R rubber components, curing of the foam is enabled also at comparatively high water percentages of the foam composition, with the cell structure being preserved, because the elastomer components cause stress equalization even in the case of shrinkage of the foam due to a water loss during hardening and thus prevent cracks or micro cracks in the cell structure. The resulting foam can thus exhibit also comparatively low air permeability or a high service life also at considerable temperature changes (caused by the weather for instance). The type R rubber material is preferably film-forming.

Natural rubber, isoprene rubber, butadiene rubber, chloroprene rubber, styrene butadiene rubber, nitrile butadiene rubber, hydrated nitrile butadiene rubber (HNBR), nitrile chloroprene rubber, butyl rubber, isoprene styrene rubber or combinations thereof can be used for instance as type R rubber material, or generally rubbers containing butadiene, where appropriate also alkyl butadiene, as copolymers. Styrene butadiene rubber (SBR), nitrile butadiene rubber (NBR, XNBR) or isoprene styrene rubber (SIR) or mixtures thereof turned out to be particularly preferable, especially SBR and NBR or combinations thereof.

Ethylene rubber, EPDM (ethylene propylene diene), EPM (ethylene propylene), CM (chlorinated PE rubber), FKM (fluoro rubber), FFKM (perfluoro rubber), FPM polypropylene tetra-flouroethylene copolymer) can be used in particular as type M rubber material.

If necessary, the film-forming polymer can also consist of or be partly formed from other rubber materials.

The type M rubber can be contained in the organic polymer at a percentage of ≧5-10% by weight or ≧15-20% by weight, particularly ≦40-40% by weight or ≦10-20% by weight or ≦5% by weight, or not at all. If necessary, the percentage of type M rubber of the organic polymer can amount to ≧30-45% by weight or ≧50-65% by weight or also ≧75-85% by weight or ≧90-95% by weight, or the polymer can entirely consist thereof, based in each case on the organic polymer content of the composition. The physical properties such as elasticity of the cured can be varied thereby. Preferably, the type M rubber material is respectively film-forming.

In particular, the total type R rubber and type M rubber of the organic polymer can be ≧30-45% by weight or ≧50-65% by weight or also ≧75-85% by weight or ≧90-95% by weight, or the polymer can entirely consist thereof. The type R rubber and type M rubber materials are each preferably film-forming.

The percentage of type R rubber in the organic polymer can be in the range of 30-100% by weight of the same. In one embodiment, the percentage of type R rubber in the organic polymer can be in the range of 45-80% by weight or 50-65% by weight. This can respectively refer also to the percentage of type R rubber, based on the solids content of the composition. The resulting foam can thus exhibit for example a rigidity which is higher than in the case of higher percentages of type R rubber material.

The percentage of type M rubber of the organic polymer can be in the range of 30-100% by weight of the same. In one embodiment, the percentage of type M rubber in the organic polymer can be in the range or 45-80% by weight or 50-65% by weight. This can also refer to the percentage of the type M rubber respectively, based on the solids content in the composition. The resulting foam can thus exhibit for example a rigidity which is higher than in the case of higher percentages of type M rubber material.

In particular, the total type R rubber and type M rubber in the organic polymer can be in the range of 30-100% by weight of the same. In one embodiment, the total type R and type M rubbers in the organic polymer can be in the range of 45-80% by weight or 50-65% by weight. This can respectively refer also to the total of type R and type M rubbers, based on the solids content of the composition.

The weight ratio of type R rubber to type M rubber can be in the range of 100:1 to 1:20 or 100:1 to 1:10, for example in the range of 100:1 to 1:1, where appropriate also in the range of 10:1 to 1:10 or 3:1 to 1:3.

Preferably, the organic polymer, particularly type R and/or type M rubber material, respectively includes no hydrolyzable and/or acid subgroups, such as ester, ether, sulfo groups or COOH groups, particularly preferably no subgroups except alkyl groups and/or halogen, especially no subgroups except alkyl groups, which applies to the type R and/or type M rubber material independently or also in combination with each other. In combination therewith or independently thereof, the organic polymer, particularly type R and/or type M rubber material, respectively includes preferably no subgroups with active hydrogen atoms that could possibly react with dissolved silicates, such as hydroxy groups, primary or secondary amino groups, primary amido groups (—NH—CO—) etc. High storage stability of the composition can be achieved thereby. Preferably, the polymer basic structures are each free of heteroatoms. Undesired side reactions with the water-soluble silicate or with a basic aqueous phase can thus be prevented and the storage stability can be increased.

Particularly preferably, the organic polymer which is used, especially elastomer or rubber material, is carboxylized copolymer (carboxylized in the side chains), whereby the resulting cured foam can exhibit particularly high adhesion to the respective construction part, particularly a construction part from an inorganic material such as concrete. In particular, carboxylized styrene butadiene copolymer can be used, which particularly preferably constitutes an elastomer in its condition applied as a film.

Preferably, ≧20-30% by weight or ≧50-60% by weight or particularly preferably ≧75-80% by weight or ≧90-95% by weight of the organic polymer are elastomers or components or rubber materials forming elastomers during curing of the foam, for example also 100% by weight, where appropriate already ≧20-35% by weight. If necessary, the organic polymers can also include non-elastomeric components, for example polyacrylates, polymethacrylates, polyamides, polyesters, styrenes, vinylacetates, polyurethanes or combinations of the same. The non-elastomeric polymer percentages can for instance be thermoplastic polymers. Thus the elastic properties of the cured foam can also be varied all in all.

The non-elastomeric polymers can for instance amount to a percentage of ≦80-90% by weight or ≦50-75% by weight or also ≦30-40% by weight of the total polymer components (each based on the dry weight of the polymers), preferably ≦10-20% by weight or ≦2-5% by weight or practically also 0% by weight, the percentage can amount to ≧2-5% by weight or ≧10-15% by weight, for example ≧20-30% by weight. The percentage of non-elastomeric polymers based on the total organic polymers hence can be in the range of 2-75% by weight or 5-50% by weight. The additional non-elastomeric polymers are preferably film-forming polymers (at 23° C.). It is thus possible by selecting the percentages of the respective polymers to adjust the film-forming properties on one side and the elastic properties on the other side as required, and particularly the percentage of water-soluble silicate can be adjusted.

The film-forming elastic polymer can be non-crosslinked. If a polymer blend is used, ≦35-50% by weight of the polymer components or ≦10-20% by weight or ≦5% by weight of the same can be non-crosslinked.

Particularly preferably, the organic polymer which is used (based on its total composition) is a polymer that is film-forming at room temperature (23° C.), so that accordingly the polymeric components, especially the dispersed polymer particles in the case of a polymer dispersion, will stick to each other and quasi melt into each other (partially) or flow into each other so as to form a coherent film during the drying or curing process of the foam. This can be demonstrated by spreading the foam on a level base and allowing the foam to dry at room temperature until reaching constant weight. Preferably, the “film-forming” property of the polymer within the scope of the invention respectively refers to the foam composition (if applicable without propellant). Alternatively or additionally, the “film-forming” property of the polymer within the scope of the invention preferably refers to the polymer dispersion which is used in each case. This turned out to be particularly preferable for providing cured foam with elastomeric properties that are beneficial for many purposes. In particular, such foam can be used for filling joints between adjacent construction parts, especially joints between windows and doors and adjacent structures constituting wall openings or reveals.

The “organic polymer” being used according to the invention especially or in case of a specific embodiment is to be understood as “film-forming organic polymer,” unless in view of the given context another meaning is given.

The film formation at 23° C. of the polymer can be achieved particularly by the adjustment of the glass transition temperature which can be ≧−40° C. or ≧−30° C. or ≧−20° C. The glass transition temperature can be ≧10-20° C. This can relate to the elastomeric and/or non-elastomeric components of the composition. Thus, a film formation of the polymeric components during the curing of the foam is achieved, film-forming together with the aqueous silicate solution (or, with regard to the cured foam, film-forming with the silicate). Foam which is produced by foaming with the aid of the propellant is thus present in the form of a homogeneous distribution of the organic polymers with the water-soluble silicate.

Particularly preferably, the organic polymer is used as an aqueous dispersion, which is characterized by favorable film-forming properties and by easy and preferably homogenous miscibility with aqueous silicate solutions (water glass). Particularly preferably, a dispersion which is tolerant to alkaline is used, i.e., one which does practically not change (e.g., change by less than 5-10% of the respective parameter) its physical properties such as viscosity, stability (absence of separations of dispersion components etc.) at 23° C. over a period of 1-2 months.

The polymer dispersion can include polymer particles in the range of 5 nm to 1,000 μm, preferably 10 nm to 500 μm or 20 nm to 100 μm, particularly preferably up to 20 to 50 μm, based in each case on the average particle size. It turned out that the resulting foam thus exhibits high foam stability (i.e., before curing) on one side and that the aqueous solution containing the water-soluble silicate and the organic polymer affords high stability and therefore longtime storability on the other side.

Preferably, the solids content of organic polymer, in particular film-forming polymer, in the aqueous phase is ≧15-17% by weight, preferably ≧20-25% by weight or ≧30% by weight. The solids content of organic polymer, particularly of film-forming polymer, in the aqueous phase can be ≦70-75% or ≦55-65% by weight or where appropriate ≦45-50% by weight or ≦25-30% by weight. Particularly preferably, the percentage of organic polymer in the aqueous phase is 3-70% by weight or 15-60% by weight or preferably 20-55% by weight, for example 25-50% by weight, or 20-45% by weight. The aqueous phase in this case is understood to be the aqueous phase without propellant. It turned out that such foam compositions exhibit high foam stability on one side and good elasticity or expansibility as well as elongation at break on the other. The organic polymer can respectively be an elastomer. The values stated above can each relate also to the solids content of organic polymer in the composition (including the propellant), particularly of film-forming polymer.

The solids content of water-soluble silicate in the aqueous phase (without propellant) preferably is ≧5-8% by weight or particularly preferably ≧12-15% by weight, where appropriate ≧20% by weight. The solids content of water-soluble silicate in the aqueous phase can be ≦40-50% by weight or ≦30-35% by weight, preferably ≦20-25% by weight. In particular, the solids content of water-soluble silicate in the aqueous phase can 5-50% by weight, preferably 8-40% by weight or 8-30% by weight, in particular 8-25% by weight or particularly preferably 10-25% by weight. The values stated above can each relate also to the solids content of silicate in the composition (including the propellant). The cell walls forming the cell structure can thus have a sufficiently high percentage of water-soluble silicate, which forms partial areas of the cell walls in the freshly prepared foam on one side and can be mixed with organic polymer present in the aqueous phase on the other side. Differently from particulate (water-insoluble) silicate dispersed or finely distributed in the aqueous phase, water-soluble silicate can form a liquid membrane that produces cell walls and solidifies vitreously or substantially amorphously under the loss of water during the drying or curing process of the foam. The cell walls thus exhibit comparatively high stability, with the water-soluble silicates being intimately and preferably homogeneously mixed with the polymer components and in case forming one phase together with the same, for example under the formation of a uniform film. The cell walls are stabilized and the foam stability and foam firmness increased through the silicates, whereby sagging of the foam is also reduced or prevented. By virtue of the comparatively high content of water-soluble silicates in the foam-producing composition, the cell walls formed under the loss of water can also exhibit comparatively high firmness, for example differently from the case in which water-insoluble silicates such as aluminosilicates and the like or hydraulically setting solids like cements are used that under absorption of water mostly produce crystalline hydrates. However, these hydrates produce comparatively hard and brittle subareas within the foam, which subareas are hardly compatible with the film forming polymers and cannot be compared with cell walls built from water-soluble silicates.

The water-soluble silicate which is used can particularly constitute alkali metal silicate or be in the form of water glass and/or in the form of a dissolved salt. The alkali metal silicate can be sodium silicate, where appropriate in combination with potassium and/or lithium ions. Potassium silicate (potassium water glass) can also be used as alkali silicate, where appropriate in combination with sodium and/or lithium ions. The sodium content (in atomic percent) can be higher than the potassium and/or lithium content of the water glass, e.g. Na content ≧50-60 at. % or ≧70-80 at. %, based on the atomic content of the alkalis of the water glass or of the aqueous phase, where appropriate also ≧90-95 at. % or practically 100 at. %.

The water glass which is used can have an alkali metal silicone atomic ratio of 1.5 to 6 or 2 to 4, preferably 2.5 to 3.5, particularly preferably 2.75 to 3.25, for example approx. 3. The silicate solution or the water glass which is used can have a solid content in the range of 20-75% by weight or 30-60% by weight. The pH of the aqueous silicate solution which is used (e.g. as water glass) can be in the range of 9-3, preferably 10 to 12.5, for example 12, whereby good compatibility with the organic polymer or the utilized aqueous polymer dispersion without functional groups with active hydrogen atoms is given, which influences the storage stability of the composition and also its film-forming properties, sprayability from the can, and its curing properties.

The pH of the aqueous phase can be ≧8-9 or ≧10, for example in the range of 8-12 or 9-12, without being limited thereto.

The ratio of organic (preferably film-forming) polymer to water-soluble silicate (in each case based on the solids content) can preferably be in the range of 10:1 to 1:2, for example 8:1 to 1:1 or 8:1 to 1.25:1, most preferably in the range of 6:1 to 1.5:1 or 5:1 to 1.5:1, particularly in the range of 4.5:1 to 1.5:1 or in the range of 4:1 to 1.75:1, specifically in the range of 3:1 to 2:1. The cured foam thus produced surprisingly exhibits high elasticity at a comparatively low reversible compressibility when low pressure is applied. Specifically, the weight ratio of organic polymer to water-soluble silicate can be ≧1.5:1 or ≧1.75:1 or preferably ≧2:1 or particularly preferably ≧2.5:1 or ≧2.75:1, whereby the storage stability of the filled foam composition is considerably increased. This limit can apply in combination with the ratios of the components of organic polymer to water-soluble silicate disclosed by the invention.

The total organic polymer and water-soluble silicate (based on its solids content) in the aqueous phase (without propellant) preferably is ≧15-20% by weight or ≧30-40% by weight, the content can be ≦70-75 by weight or ≦60% by weight, for example in the range of 20-75% by weight or 30-70% by weight, preferably in the range of 35-65% by weight or 40-60% by weight. The composition with the propellant can thus be sprayed through a nozzle while forming a homogenous foam, particularly also when being applied as a canned foam, and the foam does not exhibit any excessive shrinkage behavior and also has sufficient stability.

The total solids in the aqueous solution (total dissolved and/or undissolved solids) can be in the range of 15-75% by weight or 25-70% by weight, preferably in the range of 30-65% by weight or 35-70% by weight, particularly 40-60% by weight. Independently of that, the same applies to the content of components in the aqueous phase other than water. Accordingly, the water content of the aqueous phase in each case is the rest which gives 100% by weight, hence in the range of e.g. 25-85% by weight or 30-75% by weight or 35-70% by weight or preferably 30-65% by weight etc. Excessive shrinking of the foam during its drying is prevented while affording good sprayability of the foam through a nozzle, particularly as canned foam.

Preferably, the foam composition does not comprise further phases in addition to the propellant and the (precisely one) aqueous phase. Where appropriate, the composition can comprise also additional phases which during spraying with the propellant substantially evenly or homogeneously mix with the aqueous phase.

According to an advantageous further improvement, the aqueous phase comprises at least one water-soluble oligo- or polyphosphate or mixtures thereof, which turned out to be particularly suitable for producing a stable foam which after having been foamed into a joint fills that joint without or with only little slagging prior to curing. The oligo- or polyphosphate(s) can be contained at a percentage of ≧0.15% by weight and/or ≦10% by weight, based on the solids content of the aqueous phase, for example ≧0.25% by weight, preferably in the range of 1-6% by weight or 1.5-5% by weight.

The oligo- or polyphosphate can have 2, 3, 4, or 6 condensed phosphorus atoms or more, for example 3 or more, preferably not more than 6-8 or not more than 10-12 phosphorus atoms. Metaphosphates are comprised by the polyphosphates, and the polyphosphates can also be open-chain polyphosphates. If necessary, also orthophosphates can be used. The phosphates can be present as oligo- or polyphosphates (including metaphosphates) for ≧50-75% by weight or ≧85-95% by weight, preferably up to 100% of the same.

Such alkali metal oligo- or polyphosphates have proved themselves as particularly suitable for use as oligo- or polyphosphates because they lead to stable foams and do not negatively influence the storage stability. In particular, sodium and/or potassium phosphates can be used, and if necessary also lithium and/or ammonium ions can be present as counter ions.

Preferably, the phosphates are completely neutralized by cations. Accordingly, no hydroxyphosphates are present.

Metaphosphates which turned out to be particularly preferable are those which can constitute ≧50-75% by weight or ≧85-95% by weight or approx. 100% by weight of the phosphates.

Further, sodium tripolyphosphate (pentasodium tripolyphosphate), sodium pyrophosphate (particularly tetrasodium salt), potassium pyrophosphate (particularly tetrapotassium salt), sodium hexametaphosphate, potassium hexametaphosphate or mixtures thereof turned out to be particularly preferable. In particular, soluble tripolyphosphates, particularly of the sodium and/or potassium, or soluble metaphosphates such as hexametaphosphates, particularly of the sodium and/or potassium, turned out to be preferable. Compared to polyphosphates or tripolyphosphates, meta-phosphates can produce foams having comparatively higher elasticity.

It will be understood that if necessary sodium and/or potassium can be partly or completely replaced by lithium and/or ammonium, although this is less advantageous.

The phosphate which is used is preferably completely dissolved in the aqueous phase, where appropriate for ≧5% or ≧50-75% of the total thereof in the aqueous phase. The phosphate which is used preferably has a solubility of ≧0.25-0.5 g/liter of the aqueous phase or ≧1-2 g/liter or ≧5-10 g/liter.

Through the use of the oligo- or polyphosphate, the appearance of the foam bead introduced into the joint can be improved, particularly with regard to a uniform filling of the joint with reduced or without sagging or collapsing of the foam inside the joint after drying. The term “sagging” in this context means that the foam substantially keeps its total volume, but loses its shape while the foam bead disperses by flowing. The capability of filling the joint is thus improved. Independently thereof, the phosphates which are additionally used lead to a more uniform cell structure of the foam. Independently thereof, the flexibility of the foam can be increased if necessary by the above-mentioned phosphates, which particularly applies to metaphosphates or higher polyphosphates with 4-5 or more phosphate groups (where appropriate also as metaphosphates) such as Naexametaphosphate.

Particularly preferably, the aqueous phase of the foam composition (without propellant) comprises ≦20-25% by weight of inorganic solids (i.e., in the undissolved form in the foam composition), preferably ≦10-15% by weight or ≦3-5% by weight. The inorganic solids can for instance be intumescent materials such as expandable graphite, vermiculite, perlite etc., if necessary also fillers, UV absorbing agents or the like such as titanium dioxide, other titanates or other metal oxides, quartz sand, water-insoluble silicates including aluminosilicates or the like. Where appropriate, the percentage of inorganic (water-insoluble) solids can amount to ≧0.2-0.5% by weight, for example also ≧1-5% by weight, for example be in the range of 0.2-20% by weight. The solids can have a particle size in the range of 5 nm to 1,000 μm, for example in the range of 10 nm to 500 μm or 50 nm to 250 μm, for example in the range of 500 nm to 50 μm (based in each case on the average particle diameter), without being limited thereto. Due to the comparatively low percentage of inorganic solids, the cell walls of the resulting foam can be substantially formed by the water-soluble silicates and the organic polymer components that are finely dispersed in the aqueous phase, wherein the water-soluble silicate and preferably also the organic polymer at the same time have film-foaming properties. The cured foam can thus be adjusted to the respective requirements in a very flexible manner and it can for example exhibit a very high degree of flexibility or, due to the water-soluble silicate component, sufficient rigidity at a low specific weight and defined pore structure. Adjustment of the particle size of the mentioned solids is required in order not to impede foaming of the composition, particularly in the case of canned foam.

Preferably, the aqueous phase (without propellant) contains ≦30% by weight or ≦20-25% by weight undissolved solids that are different from the organic polymer, particularly preferably ≦10-15% by weight or ≦5-10% by weight, particularly preferably ≦1-3% by weight, or practically none. Where appropriate, the percentage of undissolved solids can be ≧0.2-0.5% by weight, for example also ≧1-5% by weight, for example be in the range of 0.1-20% by weight or 0.2-10% by weight.

Preferably, the aqueous solution (without propellant) contains ≦20-25% by weight of hydraulically setting solids, particularly preferably ≦10-15% by weight or ≦5-10% by weight, particularly preferably ≦1-3% by weight. Where appropriate, the percentage of hydraulically setting solids can be ≧0.2-0.5% by weight, for example also ≧1-5% by weight, for example be in the range of 0.1-20% by weight or 0.2-10% by weight.

Hydraulically setting solids are here understood to mean solids setting and solidifying under water absorption, for example cement, gypsum (calcium sulfate or calcium sulfate semihydrate) or the like. Due to a percentage of hydraulically setting solids which is not excessively high, the rigidity of the foam is substantially determined by the cured water-soluble silicate and, due to the film-forming properties of the same, can thus be adjusted and on the other hand varied in a vast range with the variation of the ratio to the organic polymer, while the cured foam may nevertheless exhibit in a certain manner both elastic and rigid properties.

The weight ratio of water-insoluble silicate and organic polymer, preferably film-forming organic polymer, can be adjusted in such a manner that a coherent structure of the cell walls is created by the organic polymer (high percentage of organic polymer compared to water-soluble polymer), wherein the water-soluble silicate forms subareas of the respective cell walls and thus participates in the determination of the rigidity of the foam as before. The structure of the cell walls can be particularly homogeneous so that different areas of the cell walls of organic polymer or silicate are not resolvable for instance optically by the naked eye or in case by light microscopy with a one-hundred to two-hundredfold magnification.

If necessary, the composition of the foam can be adjusted in a manner such as to construct at least in subareas of the foam (which each extend preferably over less than the average cell diameter of the foam) both continuous areas of the cell structure from organic polymer and simultaneously continuous areas from water-soluble silicate, the foam thus having elastic properties on one side and a certain degree of rigidity or pressure resistance on the other.

The aqueous phase (without propellant) can exhibit a viscosity in the range of 3-50,000 mPa·s or 5-10,000 mPa·s, preferably in the range of 10-5,000 mPa·s or 50-2,500 mPa·s, or particularly preferably in the range of 100-1,000 mPa·s. Such aqueous phase used together with a propellant turned out to be foamable particularly well and uniformly.

The aqueous polymer dispersion or solution and/or the aqueous silicate solution (e.g. water glass) which are used, can independently or both exhibit a viscosity respectively in the range of 3-50,000 mPa·s or 5-10,000 mPa·s, preferably in the range of 10-5,000 mPa·s or 10-2,500 mPa·s, or particularly preferably in the range of 15-1,000 mPa·s or 15-500 mPa·s. Such polymer dispersion can be particularly well mixed with an aqueous silicate solution (water glass) and can be very well atomized together with it by means of the propellant.

The viscosities within the scope of the invention each relate to a measuring temperature of 23° C., determined using a Brookfield Viscometer DK 1.60 Upm.

Further, the foamable aqueous phase preferably comprises a foaming agent, preferably in the form of a surfactant that can be an anionic or cationic or neutral tenside, preferably an anionic tenside. The foaming agent can also be a wax or wax composition. Waxes turned out to be particularly preferred as foaming agents in the inventive composition, also in order to produce uniform foam (uniform concerning the cell structure and/or uniform concerning the mixing of silicate solution and aqueous polymer phase or polymer dispersion). Also fatty acid esters, sulfonic acid esters and the like, also of multivalent acids, can be used. The foaming agent can be contained at a percentage of 0.001 to 10% by weight or 0.001 to 5% by weight or preferably 0.005 to 2% by weight or 0.005 to 0.5% by weight, or also without an additional foaming agent.

The aqueous phase can comprise additional components such as binders with respect to the cured foam, water repelling agents, foaming agents, rheological additives, in particular viscosity-increasing agents or thixotropic agents, anti-corrosives, preserving agents, stabilizing agents, in particular fats, powdery additives or fillers and the like. Further, if necessary the composition can comprise flame inhibitors or intumescent agents.

Preferably, the aqueous phase (without propellant) generally contains ≦20-25% by weight or ≦30-40% by weight of additional components which are different from organic polymer, water-soluble silicate and if necessary water-soluble phosphate and foaming agents as well as water, particularly preferably ≦10-15% by weight or ≦5-10% by weight, particularly preferably ≦1-3% by weight. The percentage of additional components if necessary can be ≧0.2-0.5% by weight, for example also ≧1-5% by weight, for example be in the range of 0.1-20% by weight or 0.2-10% by weight. This can refer in each case to the one-component or two-component compositions (in the present case to the total composition).

Preferably, the aqueous phase (without propellant) in general comprises ≦20-25% by weight or ≦30-40% by weight further components being different from the organic polymer, water soluble silicate and, if present, water soluble phosphate and foaming agent as well as water, more preferably ≦10-15% by weight or ≦5-10% by weight, more preferably ≦1-3% by weight. The content of the further components, if applicable, can be ≧0.2-0.5% by weight, for instance ≧1-5% by weight, e.g. in the region of 0.1-20% by weight or 0.2-10% by weight. This can be related to a one-component or to a two-component composition (in this case directed to the total composition).

The composition according to the invention is especially adapted to be provided as a one-component composition (that means that all components are present in the same chamber) or is present as such, even in case the composition is tailored as a two-component composition.

The atomized foam can be cut through (without material sticking to the cutting tool) after approx. 1-12 hours, for example after 2-8 hours, and is cured after approx. 0.5 to 2 days (in each case at 23° C. and 50% relative air humidity). This relates in each case to a free foam bead which is 2 cm wide and 2 cm high.

Particularly preferably, the foam composition of the invention can be designed as one-component foam, comprising all the components, preferably including the propellant, in one chamber. All of the above-mentioned components can be constituents of the one-component foam.

If necessary, the foam composition can be designed as a two-component foam. In this case, the additional (second) component can comprise constituents that undergo chemical reactions with alkaline components or with silicate ions, in particular neutralizing and/or decomposition reactions. These components can be for example: acidic components (particularly acidic gases, mineral acids, acidic salts (organic and/or inorganic or combinations), reactive silicates or silicone dioxide, esters or organic or inorganic compounds generally hydrolyzable by alkalis, in particular organic esters, carboxylic acid esters, silica esters, including siloxanes, amides and the like. Further, the second component can alternatively or additionally comprise water-soluble metal salts, particularly those forming hardly soluble hydroxides, in particular alkaline earth metal salts, aluminum salts, zinc salts, metal oxides and the like. These salts can comprise halogenides, particularly chlorides, sulfates, phosphates, carbonates (including hydrogen carbonates), phosphonates or other salts of phosphorous acids. These can be, for example: calcium chloride, calcium hydroxide, magnesium chloride, magnesium sulfate, aluminum sulfate (also in the binary or ternary form), in particular aluminum(iii)sulfate Al2(SO4) 3, zinc sulfate, metal oxides like calcium oxide, magnesium oxide, zinc oxide, phosphonates, in particular aluminum phosphonate, alkali solutions, salts of polyvalent amphoteric metals such as sodium aluminates or the like, metal powders, in particular also of amphoteric metals, including magnesium, zinc, aluminum. Particularly, also arbitrary combinations of the above-mentioned components can be used. Due to the constituents of the second component of the 2K-foam, in particular the above-mentioned constituents, the properties of the cured foam can be adjusted, particularly its elasticity, rigidity, water absorption capability, resistance to external influences or the like.

The second component, if present, can be contained at a percentage of 1-40% by weight, preferably 2-30% by weight, in particular 5-20% by weight or 5-10% by weight, based on the total composition (without propellant).

Accordingly, in the two-component foam composition, preferably one or both of the components are an aqueous phase, which in combination respectively comprises at least one part of the chemically dissolved silicate and organic polymer. Particularly preferably, the one component constitutes an aqueous phase, which comprises the total percentage of the chemically dissolved silicate in the total composition (comprising both components) and/or the total percentage of the organic polymer in the total composition.

Compressed gases or pressurized liquids, in particular compressed liquids exhausting gases under removal of pressure, particularly hydrocarbons, particularly preferably propane and/or butane (particularly preferred as isobutane), especially propane/isobutane, if necessary also halogenated hydrocarbons, carbon dioxide and/or ethers such as dimethylether can be used as propellants. Dimethylethers can be used particularly in two-component compositions. This propellant has qualified especially for use in one-component compositions, but if necessary also other propellants can be used. The compressed gases being used as a propellant especially may be in gaseous state at room temperature (23° C.) and normal pressure (1013 hPa). Especially, the propellant can be essentially free or is free of carbon dioxide, for instance the carbon dioxide content may be ≦25% by weight or ≦10% by weight or preferably ≦5% by weight or ≦2% by weight, for instance ≦1% by weight or ≦0.5% by weight.

Preferably, the propellant is at least essentially free from components having a coagulating effect in relation to the film-forming organic polymer, if necessary despite of the water soluble silicate, as far as this compound may have coagulating properties in respect to the film-forming organic polymer. Especially, the foam composition does not comprise gaseous coagulating components. Despite of the presence of water soluble silicates, if any, the composition preferably comprises ≦15-20% by weight or ≦5-10% by weight or preferably ≦2-3% by weight or ≦1% by weight components having a coagulating effect with respect to the film-forming organic polymer. Independently, this can be given with respect to gaseous coagulating components (20° C.; 1013 hPa).

The propellant can be generally contained at a percentage of 2 to 30% by weight or 2 to 20% by weight, in particular 2-15% by weight, based on the total weight of the foamable composition, without being limited thereto, preferably 2-10% by weight, for example 3-8% by weight, preferably in each case also ≧3% by weight or ≧1% by weight. In two-component foam, the propellant is preferably contained in the container carrying the first component during storage thereof. Especially, the content of the propellant of 2-30% by weight or 2-20% by weight, especially 2-15% by weight being directed to the total weight of the foamable composition, without being restricted thereto, preferably 2-10% by weight, for example 3-8% by weight, if applicable even ≧3% by weight or ≧1% by weight, respectively, may be directed to the content of propellant components being selected from the group of hydrocarbons, especially preferred propane and/or butane (especially preferred being isobutene), especially propane/isobutene, halogenated hydrocarbons and ether, especially being directed to the content of components being selected from the group of hydrocarbons, especially preferred propane and/or butane (especially preferred being isobutene), more specifically propane/isobutane, and ether like dimethylether.

Preferably, the foam composition is at least essentially free or free from isocyanates. The content of isocyanates in the foam composition may be ≦10-15% by weight or ≦5% by weight (directed to the total composition including propellant), preferably ≦3% by weight or ≦2% by weight, especially preferred ≦1% by weight or ≦0.5% by weight, more specifically ≦0.1% by weight or ≦0.05% by weight. Respectively, this is directed to the total content of isocyanates, namely components having at least one or more than one free isocyanate groups. Especially, this may be directed to organic isocyanates like MDI, including polymeric MDI.

The foam composition may be essentially free or may be free from polyurethanes. The content of polyurethanes in the foam composition may be ≦20% by weight or ≦10-15% by weight (directed to the total composition including propellant), preferably ≦5% by weight or ≦3% by weight, especially preferred ≦2% by weight or ≦1% by weight, specifically ≦0.5% by weight or ≦0.1% by weight. These contents in each case may be directed to the total content of urethane components.

The foam composition also can be essentially free or can be free of polyols, namely organic components having two or more hydroxy groups. The content of polyols in the foam composition may be ≦20% by weight or ≦10-15% by weight (directed to the total composition including propellant), preferably ≦5% by weight or ≦3% by weight, especially preferred ≦2% by weight or ≦1% by weight, especially ≦0.5% by weight or ≦0.1% by weight.

The foam composition of the invention can consist of an aqueous phase (apart from the dispersed polymer, if necessary with undissolved components, preferably without such components) and a propellant, wherein the aqueous phase consists of the following components, with the weight content thereof based on the aqueous phase:

a) 3 to 75% by weight organic polymer

b) 3 to 50% by weight water-soluble silicate (solids content)

c) 25-75% by weight water

d) 0-10% by weight foaming agent

e) 0-10% by weight water-soluble phosphates

f) 0-30% by weight additional components,
wherein the percentages of components a) to f) supplement each other so as to give 100%, and with propellants at a percentage of 2-30% by weight in the composition.

The weight ratio of organic polymer to water-soluble silicate (solids content) can be in the range of 20:1 to 1:20, preferably in the range of 12:1 to 1:3.

Preferably, the foam composition on the above-mentioned basis can consist of an aqueous phase and a propellant, the aqueous phase consisting of the following components, based on the aqueous phase:

a) 15 to 65% by weight organic polymer

b) 5 to 40% by weight water-soluble silicate (solids content)

c) 35-70% by weight water

d) 0-5% by weight foaming agent

e) 0-6% by weight water-soluble phosphates

f) 0-20% by weight additional components,
wherein the percentages of components a) to f) supplement each other so as to give 100%, and with propellants at a percentage of 3-20% by weight in the composition.

The weight ratio of organic polymer to water-soluble silicate (solids content) can be in the range of 8:1 to 1:1.

In both compositions specified herein, the organic polymer in each case is preferably a film-forming polymer at a percentage of ≧30-50% by weight or ≧80% by weight, particularly preferably at 90-100% by weight (based in each case on the polymer content). Particularly preferably, the film-forming polymer in each case is an elastomer.

The foam composition of the invention is washable with water or is water-soluble.

The foam which is produced hardens after a certain period of time and completely cures after an additional period of time. In the hardened condition (before curing), the foam can be made even using a tool, such as a putty knife, e.g. when arranged in a joint, without sticking to the tool.

Particularly preferably, the foam composition of the invention is present as pressurized canned foam filled into a can or canister. Preferably, the can is a pressurized container adapted for manual handling or shaking By manually shaking the can, the composition can sufficiently homogenize, and particularly the aqueous phase can be mixed with the propellant so as to spray out a homogenous foam from the can and discharge the components aqueous phase and propellant uniformly without accumulation of one component of the can. For homogenizing, a mixing body can be provided in the can which causes sufficient homogenization upon shaking the can manually or upon spraying out the can content by the pressure of the propellant, so that external aiding means are preferably not required.

By mixing the aqueous phase with the propellant, preferably by shaking the container which carries both components, and by spraying them out of the nozzle together with pressurized propellant present in the container, foam can be produced, with the aqueous phase being film-forming. Spraying out is preferably effected merely by decompression of the pressurized propellant inside the container, hence preferably without additional aids or without auxiliary means on the outside of the container. Spraying out the composition especially can be effected by manually opening the valve, so that the pressurized propellant present in the container or can is released and is sprayed out of the container together with the aqueous phase self-acting. Spraying out the composition can be effected by a discharge tube being provided with a nozzle at a free end of it. The container comprising the foam composition may be provided with a spray nozzle, spray nozzles per se are known in the art. The foam composition is arranged and suitable for this purpose. By spraying out through the nozzle, the latex component and the solution of the water-soluble silicate are present in an intimately mixed condition while forming a homogenous film (foam walls), the film being foamed into foam by means of the propellant. The foam composition of the invention is particularly arranged for homogenization by shaking so that after foaming uniform foam is produced, without residues of the foam composition in the container and without flocculation or blocking during spraying out, and this after an extended storage period, in case of several weeks up to ≧1-2 months, of the filled and closed container.

The foam composition according to the invention is especially adapted to be sprayed out of the container by means of a pressure (especially the pressure of the container pressurizing the component being stored in the container) through a pipe or a nozzle or a manually actuated pistol-like applicator (which may be fastened at the container, e.g. by screw means). Preferably, the container comprising the composition is provided with a pipe or a nozzle or a manually actuatable pistol-like applicator, through which the composition can be sprayed.

Further, a particular advantage of the inventive foam composition is that the same can also be handled in can-like containers with a volume of ≦5-10 1 or ≦2.5 1, wherein the can is manually handled at the time of atomizing the foam, particularly when stored together with the propellant. Thus, the foam can be used as an in-situ foam.

Alternatively, the foam can also be used in the factory, in this case in larger-sized containers.

The invention also relates to a method for closing construction joints or for connecting construction parts, wherein the foam is introduced into the construction joint or between the construction parts to be connected in the same manner as a conventional adhesive foam, which is first applied to a first construction part, and thereafter a second construction part is placed onto the foam that has been applied so as to connect the construction parts to each other.

The foam according to the invention is characterized by:

sufficient foam stability and viscosity

low shrinkage during curing

excellent adhesion to the substrate, in particular a mineral substrate

well-balanced setting time

high storage stability, also as a one-component canned foam

good flexibility

environmental harmlessness.

The invention also relates to a structure produced by applying the method according to the invention.

In the following, the invention will be described by way of several embodiments.

### EMBODIMENT I

According to embodiment I (composition V3), the foam has the following composition (the parts being parts by weight):

1. Organic polymer in the form of a dispersion (especially SBR latex, film-forming):

approx. 80 parts (solids content, organic film-forming polymer: 51.5%)

Viscosity of the dispersion: 100-500 mPa·s

2. Silicate solution (water glass): 25 parts

Solids content (percentage of water-soluble silicate): 52%

Na/Si ratio: 3

Viscosity: approx. 50-200 mPa·s

pH: 12

3. Phosphate (sodium tripolyphosphate): 5.5 parts

4. Emulsifier: 0.2 parts

5. Propellant (propane/isobutane): 10 parts

Within the scope of the embodiments, the organic polymer respectively constitutes an elastomer, particularly SBR.

Components 3 and 4 are not compulsory for all applications, but are beneficial.

Homogenization Properties (Shakeability):
The composition is characterized by excellent homogenization properties (shaking properties), namely homogenization of the can content by manual shaking To this end, the can filled with propellant is powerfully shaken manually 10 times using a shaking body in the form of a ball inside the can as a mechanical homogenizing aid. Thereafter, the can content is uniformly homogenized so that the foam can be uniformly atomized throughout the content of the can and with the composition remaining unchanged.

Homogenization Properties After 2 Days:
After several days in its filled condition in the can (e.g. 2 days), the foam composition can be homogenized very well by shaking under the mentioned conditions.

Foam Stability:
The foam which is produced by atomization from the can is substantially stable, with only little tendency to collapsing (less than 30-40% by volume between application and curing), measured on a free foam bead (bead on substrate) 2 cm wide and 2 cm high.

Joint Filling:
If the foam is used for filling a standard joint (3 cm wide; 10 cm deep) (excessive foam being removed immediately after filling), the joint is substantially completely filled after the foam has cured, with only little shrinkage (less than 10%).

Elasticity, Ultimate Elongation:
The foam which is produced is soft foam exhibiting good elasticity and good elongation properties. In particular, the foam is capable of well compensating dislocation in the construction parts that present the joint walls, the dislocation occurring as a result of temperature changes and especially as a result of shocks or vibration.

Adhesion:
Adhesion of the foam to mineral substrates, metals such as aluminum or steel, and to wood, but also to plastic materials (e.g. PE or PVC) is good. Adhesion of the foam to the substrate is stronger than ultimate elongation of the foam. Under a lateral spacing of the construction parts forming the joint, the foam itself will crack, but the adhesion of the foam to the construction components will persist.

Sprayability:
Further, the foam composition can be uniformly foamed without flocculation, i.e. without flakes that possibly adhere to the foam bead and are not homogeneously incorporated in the foam bead.

Sprayed foam (foam bead 2 cm wide and 2 cm high) can be cut through after approx. 8 hours (without material sticking to the cutting tool) and is cured after approx. 1 day (in each case at 23° C. and 50% relative air humidity).

Where appropriate, the composition can contain up to 10-20% by weight or even more of further additives or auxiliary materials, for example foaming agents, rheological modifying agents, stabilizing agents, inorganic and organic fillers (not film-forming, preferably no elastomeric materials), without being limited thereto.

In a further modified form, the foam which is employed can be used as two-component foam. Based on the composition according to embodiment 1, the additional component can contain 2-20% by weight, preferably 5-10% by weight of modified constituents. These constituents are used as second component if the same undergoes undesired reactions with alkali solutions or water-soluble silicates, for example neutralizing reactions, decomposition reactions, including hydrolytic separation of esters, ester interchange, production of water-insoluble salts by precipitation reactions, or the like. There can be used for example in equal percentages by weight: Mineral acids, acidic salts such as hydrogen carbonates, hydrogen phosphates, organic esters, water-soluble alkaline earth metals, aluminum phosphonates. Thus the properties of the foam can be adjusted with respect to its water repelling properties, pore structure, fire properties and the like.

### EMBODIMENT II

According to embodiment II, the foam has the following composition (the parts being parts by weight, the components being the same as in embodiment I):

1. Organic polymer in the form of a dispersion (especially SBR latex): approx. 65 parts

2. Silicate solution (water glass): 36 parts

3. Phosphate (sodium tripolyphosphate): 1.5 parts

4. Emulsifier: parts

5. Propellant (propane/isobutane): 6.5 parts

The homogenization properties of this composition are somewhat better than those of embodiment I. Apart from that, the properties of the foam and the composition are similar to embodiment I.

The foam compositions according to the invention are particularly characterized by good homogenizability by shaking a foam can, and by good foam stability, even inside the joint. In contrast thereto (with the use of the same components), foam stability in the case of pure latex foam has been found to be insufficient. The foam practically collapsed instantly, the homogenizability by shaking the can was insufficient at an excessive percentage of silicate or was even blocked during atomization.

### COMPARATIVE EXAMPLE SERIES 1

These comparative examples VGI-1 to VGI-5 comprise embodiment I (VGI-3). The components are each identical with those of embodiment I, merely the percentages vary. The percentages are here respectively expressed as parts by weight.

| | VGI-1 | VGI-2 | VGI-3 | VGI-4 | VGI-5 |
|---|---|---|---|---|---|
| Comp. 1 | 105 | 82 | 80 | 63 | 42 |
| Comp. 2 | — | 20 | 25 | 40 | 62 |
| Comp. 3 | 5.5 | 5.5 | 5.5 | 5.5 | 5.5 |
| Comp. 4 | 0.2 | 0.2 | 0.2 | 0.2 | 0.2 |
| Comp. 5 | 10 | 10 | 10 | 10 | 10 |
| Homogenizability | 5 | 5 | 5 | 1 | — |
| | | | | (blocked) | (excessively thick) |
| Homogenizability after 2 days | 5 | 3 | 3 | 1 | |
| Structure of foam bead | ¹⁾ | 4 | 4 | ²⁾ | ²⁾ |
| Joint filling | ¹⁾ | 5 | 5 | ²⁾ | ²⁾ |
| Elasticity | ¹⁾ | 5 | 4 | 2 | |
| Expansibility | ¹⁾ | 5 | 4 | 1 | |
| Spray-ability | 4 | 4 | 4 | 1 | |

¹⁾ No foam bead obtained. Foam collapsed directly after spraying out through a nozzle.
²⁾ No foam bead obtained because foam could not be sprayed out.

The properties are rated using a scale from 5 (very good) to 1 (barely utilizable for determining the property).

Very good homogenizability produces a completely homogeneous foam composition after manually shaking the filled can 10 times.

The structure of the foam bead relates to the shape of the free foam bead which upon atomization presents its width even after curing.

The joint filling relates to foaming a standard joint (3 cm wide, 10 cm deep). Very good foam filling means that when the joint is completely filled with foam (excessive material removed), the foam practically completely fills the joint even after curing. Sagging by less than 10% of the joint depth is considered grade 1.

Elasticity and expansibility here constitute relative characteristics within the experimental series with respect to the requirements to expansibility during filling door and window joints with respect to the adjacent reveal, taking into account vibrations as a permanent load.

Very good sprayability means that the foam bead is coherent in itself, without splashes or without the production of foam flakes that are not incorporated in the bead and only have a weak bond to the same and in case only loosely adhere to the bead.

### COMPARATIVE EXAMPLES SERIES 2

The compositions of this series are based on the compositions corresponding to embodiment II.

In the following, the solids ratio of organic polymer/silicate (referred to as latex ratio)is modified (latex index: ratio of the solids content of (i) polymer, particularly of film-foaming organic polymer and (ii) water-soluble silicate) based on a composition corresponding to embodiment 2. The percentages of organic polymer and water-soluble silicate are varied oppositely to each other while the percentages of the other components are kept constant.

Concerning the components and the rating of the properties, it is referred to the comparative examples of series 1 which are fully incorporated herein by reference. This series contains a low percentage of phosphate. The storage stability of the foam compositions in the can thus clearly improves and easily reaches 9 months, without modification of the homogenization and foaming properties.

| | VGII-1 | VGII-2 | VGII-3 | VGII-4 | VGII-5 |
|---|---|---|---|---|---|
| Latex index | 1.82 | 2.08 | 2.4 | 2.85 | 3.3 |
| Sprayability after | 2 | 3 | 3 | 5 | 5 |
| 3 days of storage | | | | | |
| Joint filling (%) | 1 | 5 | 4 | 4 | 3 |
| Homogenizability | 5 | 5 | 5 | 5 | 5 |
| Homogenizability | 1 | 4 | 5 | 5 | 5 |
| after 2 days | | | | | |
| Homogenizability | 1 | 1 | 4 | 5 | 5 |
| after 4 days | | | | | |
| Homogenizability | 1 | 1 | 2 | 5 | 5 |
| after 8 days | | | | | |

This shows that the joint filling properties deteriorate with an increasing latex index, while homogenizability (shaking properties) remains constant if the latex index or the solids ratio of organic polymer: water-soluble silicate is greater than 2.65, for example 2.85 or higher. Therefore, a latex index of ≧2.65 or ≧2.85 is generally preferred within the scope of the invention. On the other hand, the joint filling properties deteriorate with an increasing latex index while homogenizability remains constant from a value which is already higher. The latex index should preferably be ≧1.5 or ≧2, at least in this composition or generally.

Based on the above composition with a latex index of 1.82 (corresponding to comparative example 2), the propellant content (propane/isobutane) was varied between 1 and 25 parts. Less than a minimum content of 3% by weight will mostly not yield a satisfying foaming behavior. Increasing the propellant content to more than 10-12% by weight will result in worse joint filling and in increased foam splashes during foam spraying. A propellant content in the range of 4-10% by weight turned out to be beneficial for this purpose. Percentages of the propellant higher than 8% by weight will result in worse homogenization properties (shaking properties), and above 10% by weight a significant deterioration can be observed after 4 days or longer.

Further, the influence of the soluble phosphate content on the composition will be examined.

Based on a latex index of 2.85 and a propellant content of 6% by weight (for the rest corresponding to the composition according to comparative example 2), soluble phosphate (here: Natripolyphosphate) percentages of more than 6% by weight only yield very bad (grade 1) homogenization properties after 4 days, above 5% by weight only very bad (grade 1) homogenization properties after 5 days, based in each case on the content of the aqueous solution. Above 5% by weight, turbulent foam is observed (the sprayed foam bead is very agitated and the foam moves). Above 2.5% by weight of soluble phosphate, the homogenization properties begin to deteriorate slowly. The soluble phosphate content has influence on the appearance of the foam bead formed in the joint which is more uniform, particularly with respect to the evenness of the foam structure (pore pattern), in particular at percentages of ≧0.25-0.5% by weight. A soluble phosphate content of up to 3% by weight, if necessary up to 4% by weight, turned out to be particularly advantageous.

In case with respect to the invention reference is made to a “part,” this is considered to be “part by weights,” unless any other meaning is given in view of the given context.

1.-22. (canceled)

23. A foam composition for building purposes, particularly for filling joints or for connecting construction parts, the foam composition comprising a foamable aqueous phase and a propellant which foam when sprayed together through a nozzle, the foamable aqueous phase comprising at least one organic polymer and inorganic components, wherein the inorganic components comprise a water soluble silicate chemically dissolved in the aqueous phase to form a silicate solution which is film-foaming,
wherein the organic polymer is present in a form of a dispersion or aqueous solution and produces a silicate-polymer-foam when foamed together with the silicate solution,
wherein the organic polymer is present at a percentage of ≧3% by weight, based on dry substance in the aqueous phase,
wherein the water-soluble silicate is present at a percentage of ≧3% by weight, based on dry substance in the aqueous phase, and
wherein the organic polymer and the water-soluble silicate are present at a weight ratio of 20:1 to 1:20, based respectively on dry substance in the aqueous phase.

24. The foam composition according to claim 23, wherein the weight ratio of the organic polymer to the water-soluble silicate is in a range of 12:1 to 1:3, based in each case on their solids content.

25. The foam composition according to claim 23, wherein the organic polymer comprises an elastomeric polymer.

26. The foam composition according to claim 23, wherein the organic polymer is a film-forming organic polymer.

27. The foam composition according to claim 23, wherein the polymer is selected from type R rubber material and type M rubber material, optionally styrene butadiene copolymer rubber material or vinyl halide alkylene copolymer, and mixtures thereof.

28. The foam composition according to claim 23, wherein the organic polymer comprises ≦75% by weight non-elastic polymers, based on the total organic polymer.

29. The foam composition according to claim 23, wherein the organic polymer, optionally organic elastomer, is present in the aqueous phase at a percentage of ≧52.5% by weight and ≦95% by weight, based on solids content of the aqueous phase.

30. The foam composition according to claim 23, wherein the water-soluble silicate comprises an alkali metal silicate or a mixture thereof.

31. The foam composition according to claim 23, wherein the water-soluble silicate is present at a percentage of ≧8% by weight, based on solids content of the aqueous phase.

32. The foam composition according to claim 23, wherein the aqueous phase contains at least one oligo- or polyphosphate or mixtures thereof.

33. The foam composition according to claim 32, wherein the oligo- or polyphosphate is present at a percentage of ≧0.15% by weight and ≦10% by weight, based on solids content of the aqueous phase.

34. The foam composition according to claim 23, wherein the aqueous phase or produced the foam contains ≦20-30% by weight undissolved organic solids.

35. The foam composition according to claim 23, wherein the aqueous phase contains ≧20% by weight and ≦75% by weight water.

36. The foam composition according to claim 23, wherein in a cured state the foam forms a flexible soft foam or a semi-rigid foam.

37. The foam composition according to claim 23, wherein the aqueous phase exhibits a viscosity in a range of 3-50,000 mPa·s (measured at 23° C.).

38. The foam composition according to claim 23, wherein the foam composition comprises an aqueous phase and a propellant,
wherein the aqueous phase comprises the following components, with the weight content thereof based on the aqueous phase:
a) 3 to 75% by weight organic polymer
b) 3 to 50% by weight water-soluble silicate (solids content)
c) 25-75% by weight water
d) 0-10% by weight foaming agent
e) 0-10% by weight water-soluble phosphates
f) 0-30% by weight additional components,
wherein the percentages of components a) to f) supplement each other so as to give 100%,
and the propellant is present at a percentage of 2-30% by weight in the composition.

39. The foam composition according to claim 23, wherein the foam composition comprises an aqueous phase and a propellant,
wherein the aqueous phase comprises the following components, with the weight content thereof based on the aqueous phase:
a) 15 to 65% by weight organic polymer
b) 5 to 40% by weight water-soluble silicate (solids content)
c) 35-70% by weight water
d) 0-5% by weight foaming agent
e) 0-6% by weight water-soluble phosphates
f) 0-20% by weight additional components,
wherein the percentages of components a) to f) supplement each other so as to give 100%,
and the propellant is present at a percentage of 3-20% by weight in the composition.

40. The foam composition according to claim 23, which is a one-component composition.

41. The foam composition according to claim 23, which is a two-component composition, wherein one of the components is an aqueous phase, which in combination comprises at least one part of the chemically dissolved silicate and/or of the organic polymer.

42. The foam composition according to claim 23, which is present in a form of a pressurized canned foam filled into a can.

43. A method for closing a building joint or for connecting construction parts, the method comprising applying the foam composition according to claim 23 by introducing the foam composition into the building joint or between the construction parts to be connected, and thereafter allowing the foam composition to cure.

44. A structure comprising a building joint or a plurality of construction parts, and a foamed foam composition according to claim 23, wherein the joint is at least partly filled with the foamed foam composition or at least two closely spaced construction parts are connected to each other by gluing with the foamed foam composition.
